(19) United States
(12) Patent Application Publication
(10) Pub. No.: US 2026/0170956 A1
(43) Pub. Date: Jun. 18, 2026

(54) METHODS FOR PERFORMING TRAFFIC COORDINATION AND ROADSIDE DEVICES FOR PERFORMING THE SAME

(71) Applicants: Hyundai Motor Company, Seoul (KR); Kia Corporation, Seoul (KR)

(72) Inventor: Michele Rondinone, Ruesselsheim (DE)

(21) Appl. No.: 19/395,221

(22) Filed: Nov. 20, 2025

(30) Foreign Application Priority Data
Dec. 17, 2024 (DE) 102024138179.5

(51) Int. Cl. G08G 1/0967; B60W 50/14; B60W 60/00; G08G 1/01

(52) U.S. Cl. CPC G08G 1/096725; B60W 50/14; B60W 60/0027; G08G 1/0112; B60W 2552/05; B60W 2552/10; B60W 2554/4026; B60W 2554/4029; B60W 2554/4041; B60W 2556/45

(57) ABSTRACT

A roadside device for performing traffic coordination, and methods of use, are provided. The roadside device may comprise a transceiver configured to receive a first maneuver coordination message (MCM) from a cooperative automated vehicle (CAV), the MCM being configured to inform an intended maneuver of the CAV, a detector configured to detect a target object, and a processor configured to determine whether a predicted trajectory of the target object conflicts with the intended maneuver of the CAV and provide a coordination message as a signal viewable to a user of the target object when it is determined that the predicted trajectory of the target object conflicts with the intended maneuver of the CAV.

### CROSS-REFERENCE TO RELATED APPLICATION

The present application claims, under 35 U.S.C. §119(a), the benefit of German Patent Application No.102024138179.5, filed Dec. 17, 2024, the entire contents of which are incorporated herein by reference.

### BACKGROUND

### (a) Technical field

The present disclosure relates to methods for performing cooperative automated vehicle coordination with non-cooperative and/or non-automated traffic users and roadside devices for performing the same.

### (b) Background

Maneuver Coordination Messages (MCMs), currently being standardized at the European Telecommunications Standards Institute (ETSI), will allow explicit maneuver coordination protocols between cooperative automated vehicles (CAVs) equipped with V2X radio technologies (ITS-G5, LTE-V2X, 5G-V2X, etc.).

A CAV continuously transmits MCMs (e.g., every 100ms) containing its current planned intentions (e.g., maneuvers, trajectories, etc.). As CAVs move and update their intentions, the content of their MCMs also change to reflect these updates. By exchanging planned intentions with other CAVs and negotiating maneuvers, a variety of use cases can be supported by CAVs.

Additionally, EU-funded research projects, such as TransAID, have proposed using MCMs transmitted by the road infrastructure to suggest individualized maneuvers to specific CAVs to address certain traffic situations. For example, a roadside unit located at a merging section could suggest a CAV on a highway to adapt its speed to let an on-ramp CAV safely and efficiently merge on the highway.

Maneuver coordination use cases have the potential to increase traffic safety and efficiency. Unfortunately, maneuver coordination is not initially possible with traffic users that are Non-cooperative (NC in the following, i.e. legacy vehicles as well as automated vehicles, pedestrian, bikers, and other traffic users that cannot share planned or intended maneuvers via V2X because not at all equipped with V2X, or using incompatible V2X radio technologies and standards, and/or non-automated (NA) vehicle (e.g., legacy vehicles, pedestrian, bikers, and other traffic users that cannot compute planned intended maneuvers, and hence cannot share it via V2X).

Hence, there is a need to find solutions for developing an application method to administrate maneuver coordination between CAVs and other non-automated and/or non-cooperative traffic users at specific road infrastructure locations.

### SUMMARY

The application method implements a generic framework with multiple logic modules to identify and enable this coordination in a pre-defined but extendable set of traffic situations.

To this end, the present disclosure provides a roadside device for a traffic coordination in accordance with claim 1 and a method for traffic coordination in accordance with claim 15.

According to one aspect of the disclosure, a roadside device for a traffic coordination, comprising: a transceiver configured to receive maneuver coordination messages, MCMs, from a cooperative automated vehicle, CAV, informing an intended maneuver of the CAV;

a detector configured to detect a target object; a processor configured to predict a trajectory of the target object, determine whether the predicted trajectory of the target object conflicts with the intended maneuver of the CAV, to provide a coordination message in a way that the coordination message can be seen by a user of the target object, when it is determined that the predicted trajectory of the target object conflicts with the intended maneuver of the CAV.

According to a second aspect of the disclosure, a method of traffic coordination performed by a roadside device, comprising: receiving maneuver coordination messages, MCMs, from a cooperative automated vehicle, CAV, informing an intended maneuver of the CAV; detecting a target object; predicting a trajectory of the target object, determining whether the predicted trajectory of the target object conflicts with the intended maneuver of the CAV, and providing a coordination message in a way that the coordination message can be seen by a user of the target object when it is determined that the predicted trajectory of the target object conflicts with the intended maneuver of the CAV.

According to an embodiment, the roadside device may further comprise: an optical unit configured to illuminate at least a part of a road along the predicted trajectory of the target object.

According to an embodiment, the processor may be configured to cause the optical unit to signalize the coordination message on the road along the predicted trajectory of the target object.

According to an embodiment, the optical unit may be a light emitting device, LED, beam.

According to an embodiment, the processor may be configured to convert the coordination message in a format suitable to a navigation system of the target object such that the coordination is signalized on the navigation system.

According to an embodiment, the detector may be further configured to keep monitoring a movement of the target object after the coordination is signalized.

According to an embodiment, the monitored movement of the target object may be at least one of a moving speed and a moving path of the target object.

According to an embodiment, the processor may be configured to generate MCMs to be transmitted to the CAV to reflect the predicted movement of the monitored target object.

According to an embodiment, theseMCMs may indicate that the intended maneuver of the CAV can be maintained, when the movement of the target object is adapted according to the coordination message.

According to an embodiment, these MCMs may indicate that the intended maneuver of the CAV has to be changed, when the movement of the target object is not adapted.

According to an embodiment, the target object may not be compatible with a MCM.

According to an embodiment, the target object may be one of a non-automated vehicle, a non-cooperative vehicle, a bike, and a pedestrian.

According to an embodiment, the predicted trajectory of the target object may be located on a highway lane merging with an entry section, and the intended maneuver of the CAV may be to enter the entry section.

According to an embodiment, the predicted trajectory of the target object may be located on an internal circle of a roundabout, and the intended maneuver of the CAV may be to enter the roundabout.

According to embodiments of the present disclosure, CAVs can coordinate their maneuvers even with non-automated and/or non-cooperative traffic users. Therefore, the traffic safety and efficiency potential of maneuver coordination can be maintained without exclusively depending on the presence of cooperative automated road users.

According to an aspect of the present disclosure, a roadside device for performing traffic coordination is provided. The roadside device may comprise a transceiver configured to receive a first maneuver coordination message (MCM) from a cooperative automated vehicle (CAV), the MCM being configured to inform an intended maneuver of the CAV, a detector configured to detect a target object, and a processor configured to determine whether a predicted trajectory of the target object conflicts with the intended maneuver of the CAV and provide a coordination message as a signal viewable to a user of the target object when it is determined that the predicted trajectory of the target object conflicts with the intended maneuver of the CAV.

According to an exemplary embodiment, the processor may be configured to predict the trajectory of the target object.

According to an exemplary embodiment, the roadside device may comprise an optical unit configured to illuminate at least a part of a road along the predicted trajectory of the target object.

According to an exemplary embodiment, the processor may be configured to cause the optical unit to display the coordination message on the road along the predicted trajectory of the target object.

According to an exemplary embodiment, the optical unit may comprise a light emitting diode (LED) beam.

According to an exemplary embodiment, the processor may be configured to convert the coordination message into a format suitable to a navigation system of the target object such that the coordination message is signalized on the navigation system.

According to an exemplary embodiment, the detector may be further configured to keep monitoring a movement of the target object after the coordination message is displayed.

According to an exemplary embodiment, the monitored movement of the target object may comprise at least one of a moving speed and a moving path of the target object.

According to an exemplary embodiment, the processor may be configured to generate a second MCM to be transmitted to the CAV based on the monitored movement the target object.

According to an exemplary embodiment, when the movement of the target object is adapted according to the coordination message, the second MCM may indicate that the intended maneuver of the CAV can be maintained.

According to an exemplary embodiment, when the movement of the target object is not adapted, the second MCM may indicate that the intended maneuver of the CAV (100) has to be changed.

According to an exemplary embodiment, the target object may not support a MCM to be operated.

According to an exemplary embodiment, the target object may comprise one of a non-automated vehicle, a non-cooperative vehicle, a bike, and a pedestrian.

According to an exemplary embodiment, the predicted trajectory of the target object may be located on a highway lane merging with an entry section, and the intended maneuver of the CAV may be to enter the entry section.

According to an exemplary embodiment, the predicted trajectory of the target object may be located on an internal circle of a roundabout, and the intended maneuver of the CAV may be to enter the roundabout.

According to an aspect of the present disclosure, a method of traffic coordination performed by a roadside device is provided. The method may comprise receiving a first maneuver coordination message (MCM) from a cooperative automated vehicle (CAV), wherein the MCM is configured to inform an intended maneuver of the CAV, detecting a target object, and, using a processor, determining whether a predicted trajectory of the target object (200) conflicts with the intended maneuver of the CAV and providing a coordination message as a signal viewable by a user of the target object when it is determined that the predicted trajectory of the target object conflicts with the intended maneuver of the CAV.

According to an exemplary embodiment, the method may comprise, using the processor, predicting the trajectory of the target object.

According to an exemplary embodiment, the method may comprise, using an optical unit, displaying the coordination message on a road along the predicted trajectory of the target object. The optical unit may be configured to illuminate at least a part of the road along the predicted trajectory of the target object.

According to an exemplary embodiment, the optical unit may comprise a light emitting diode (LED) beam.

According to an exemplary embodiment, the method may comprise, using the processor, converting the coordination message into a format suitable to a navigation system of the target object such that the coordination message is signalized on the navigation system.

The disclosure will be explained in greater detail with reference to exemplary embodiments depicted in the drawings as appended.

### BRIEF DESCRIPTION OF THE DRAWINGS

The accompanying drawings are included to provide a further understanding of the present disclosure and are incorporated in and constitute a part of this specification. The drawings illustrate the embodiments of the present disclosure and together with the description serve to explain the principles of the disclosure. Other embodiments of the present disclosure and many of the intended advantages of the present disclosure will be readily appreciated as they become better understood by reference to the following detailed description. The elements of the drawings are not necessarily to scale relative to each other. In the figures, like reference numerals denote like or functionally like components, unless indicated otherwise.

FIG. 1 illustrates an example of scenarios where traffic coordination is required, according to an exemplary embodiment of the present disclosure.

FIG. 2 illustrates an example of scenarios where traffic coordination is required, according to an exemplary embodiment of the present disclosure.

FIG. 3 illustrates an example of scenarios where traffic coordination is performed between CAVs, according to an exemplary embodiment of the present disclosure.

FIG. 4 illustrates an example of a schematic diagram of a roadside device for traffic coordination, according to an exemplary embodiment of the present disclosure.

FIG. 5 illustrates an example of scenarios where traffic coordination may be applied, according to an exemplary embodiment of the present disclosure.

FIG. 6 illustrates an example of scenarios where traffic coordination may be applied, according to an exemplary embodiment of the present disclosure.

FIG. 7 illustrates an example of a flow chart showing a method for traffic coordination, according to an exemplary embodiment of the present disclosure.

FIG. 8 illustrates a block diagram schematically illustrating a computer program product, according to an exemplary embodiment of the present disclosure.

FIG. 9 illustrates a block diagram schematically illustrating a data storage medium, according to an exemplary embodiment of the present disclosure.

Although specific embodiments are illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

The operation and control of vehicles is becoming more autonomous over time, and most vehicles will likely become fully autonomous in the future. Vehicles that include some form of autonomy or otherwise assist a human operator may be referred to as “computer-assisted or autonomous driving” vehicles. Computer-assisted or autonomous driving (CA/AD) vehicles may include Artificial Intelligence (AI), machine learning (ML), and/or other like self-learning systems to enable autonomous operation. Typically, these systems perceive their environment (e.g., using sensor data) and perform various actions to maximize the likelihood of successful vehicle operation.

The operation and control of vehicles is becoming more autonomous over time, and most vehicles will likely become fully autonomous in the future. Vehicles that include some form of autonomy or otherwise assist a human operator may be referred to as “computer-assisted or autonomous driving” vehicles. Computer-assisted or autonomous driving (CA/AD) vehicles may include Artificial Intelligence (AI), machine learning (ML), and/or other like self-learning systems to enable autonomous operation. Typically, these systems perceive their environment (e.g., using sensor data) and perform various actions to maximize the likelihood of successful vehicle operation.

The Vehicle-to-Everything (V2X) applications (referred to simply as “V2X”) include the following types of communications Vehicle-to-Vehicle (V2V), Vehicle-to-Infrastructure (V2I) and/or Infrastructure-to-Vehicle (I2V), Vehicle-to-Network (V2N) and/or network-to-vehicle (N2V), Vehicle-to-Pedestrian communications (V2P), and ITS station (ITS-S) to ITS-S communication (X2X). V2X applications can use co-operative awareness to provide more intelligent services for end-users. This means that entities, such as vehicle stations or vehicle user equipment (vUEs) including such as CA/AD vehicles, roadside infrastructure or roadside units (RSUs), application servers, and pedestrian devices (e.g., smartphones, tablets, etc.), collect knowledge of their local environment (e.g., information received from other vehicles or sensor equipment in proximity) to process and share that knowledge in order to provide more intelligent services, such as cooperative perception, maneuver coordination, and the like, which are used for collision warning systems, autonomous driving, and/or the like.

One such V2X application comprises Intelligent Transport Systems (ITS), which are systems to support transportation of goods and humans with information and communication technologies in order to efficiently and safely use the transport infrastructure and transport means (e.g., automobiles, trains, aircraft, watercraft, etc.). Elements of ITS are standardized in various standardization organizations, both on an international level and on regional levels. Communications in ITS (ITSC) may utilize a variety of existing and new access technologies (or radio access technologies (RAT)) and ITS applications. Examples of these V2X RATs include Institute of Electrical and Electronics Engineers (IEEE) RATs and Third Generation Partnership (3GPP) RATs. The IEEE V2X RATs include, for example, Wireless Access in Vehicular Environments (WAVE), Dedicated Short Range Communication (DSRC), Intelligent Transport Systems in the 5 GHz frequency band (ITS-G5), the IEEE 802.11p protocol (which is the layer 1 (L1) and layer 2 (L2) part of WAVE, DSRC, and ITS-G5), and sometimes the IEEE 802.16 protocol referred to as Worldwide Interoperability for Microwave Access (WiMAX). The term “DSRC” refers to vehicular communications in the 5.9 GHz frequency band that is generally used in the United States, while “ITS-G5” refers to vehicular communications in the 5.9 GHz frequency band in Europe. Since the present embodiments are applicable to any number of different RATs (including IEEE 802.11p-based RATs) that may be used in any geographic or political region, the terms “DSRC” (used, among other regions, in the U.S.) and “ITS-G5” (used, among other regions, in Europe) may be used interchangeably throughout this disclosure. The 3GPP V2X RATs include, for example, cellular V2X (C-V2X) using Long Term Evolution (LTE) technologies (sometimes referred to as “LTE-V2X”) and/or using Fifth Generation (5G) technologies (sometimes referred to as “5G-V2X” or “NR-V2X”). Other RATs may be used for ITS and/or V2X applications such as RATs using UHF and VHF frequencies, Global System for Mobile Communications (GSM), and/or other wireless communication technologies.

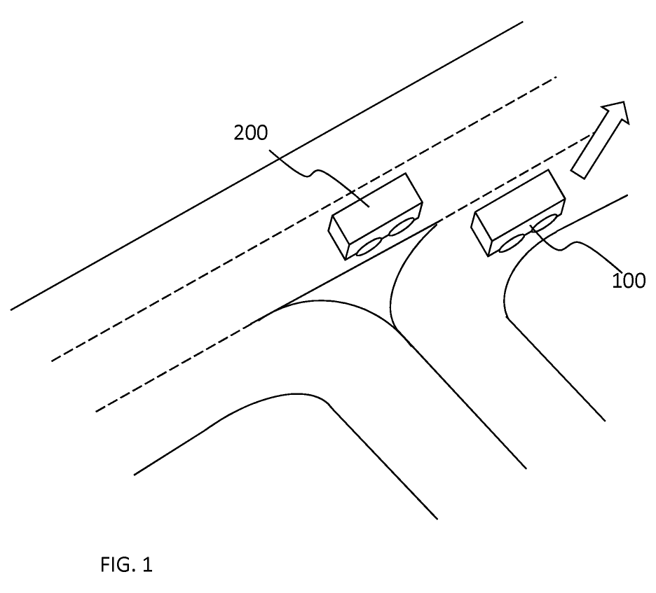

Referring now to FIG. 1, an example of scenarios where a traffic coordination is required is illustratively depicted, in accordance with an exemplary embodiment of the present disclosure.

As shown in FIG. 1, in this example, a target object 200 that needs to be coordinated with CAV 100 may comprise a NC-AV. The NC-AV 200 may be configured to compute/adapt its planned maneuver/trajectory but may not or cannot share it because it has no V2X. As a consequence, the CAV 100 may have to interpret with own sensors if it is safe to merge. This can happen only at later stage, when CAV is on the ramp and its view of the NC-AV 200 is not obstructed. The CAV 100 has to act more conservatively and might discard possible merging opportunities, which implies less traffic efficiency. Moreover, as NC-AV 200 has no V2X, it cannot acknowledge with an MCM that it is decelerating to let the CAV 100 merge. Due to this uncertainty, the CAV might take merging decisions with a given safety risk.

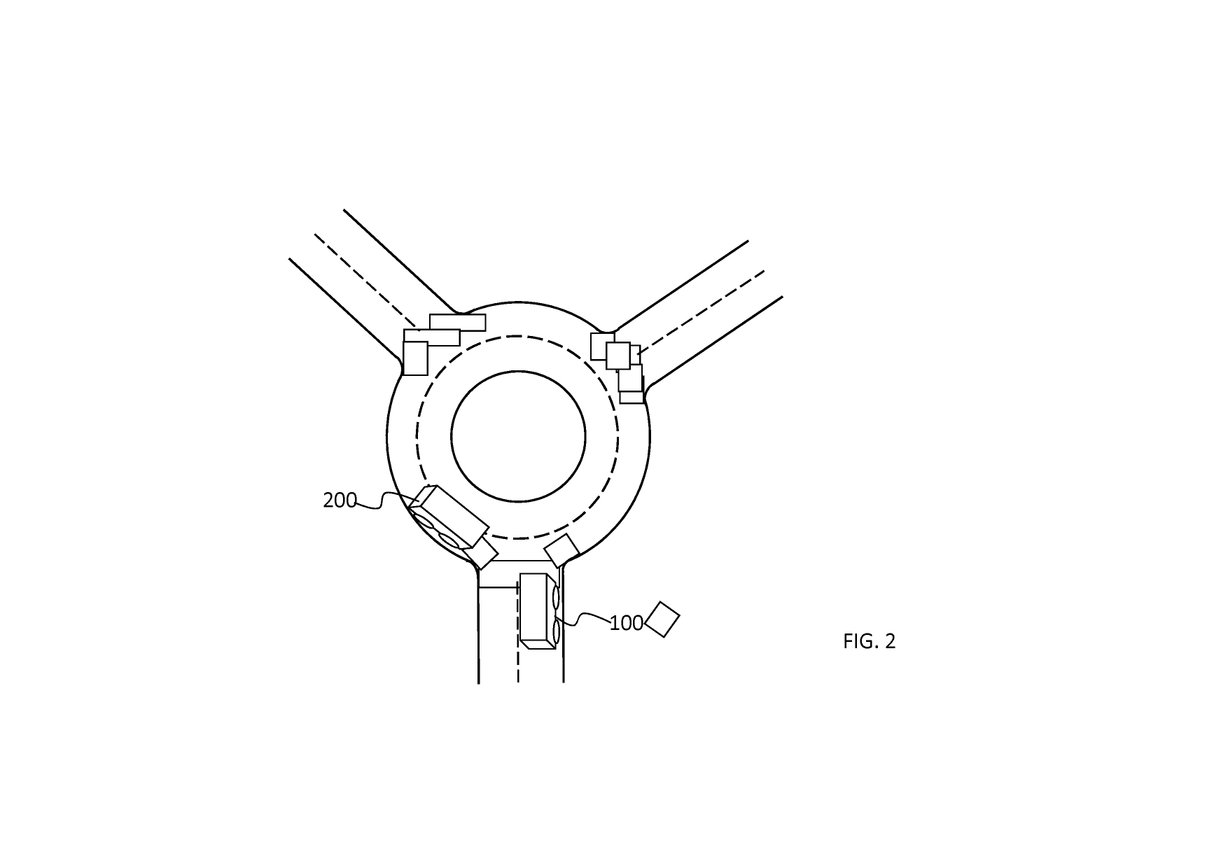

FIG. 2 shows another example of scenarios where a traffic coordination is required, in accordance with an exemplary embodiment of the present disclosure.

As shown in FIG. 2, in this example, the target object 200 that needs to be coordinated with CAV 100 may comprise a bike. As the biker 200 is not automated, it cannot compute and share its intention to exit the roundabout. As a consequence, the CAV 100 has to interpret with own sensors if it is safe to enter the roundabout or if it has to wait for the biker 200 to stay on the roundabout. The CAV 100 may have to act more conservatively and might discard possible drive-in opportunities, which implies less traffic efficiency. Moreover, as the bike 200 cannot compute and share its intention in an MCM, CAVs 100 decisions to enter the roundabout cannot be explicitly acknowledged by the bike 200. Due to this uncertainty, the CAV 100 might take drive-in decisions with a given safety risk.

As shown in the above examples (e.g., as shown in FIG. 1 and FIG. 2), an application method for CAVs to establish and execute maneuver coordination also with non-automated and/or non-cooperative traffic users (NA-NCs in the following) would considerably extend the possibilities to increase traffic safety and efficiency.

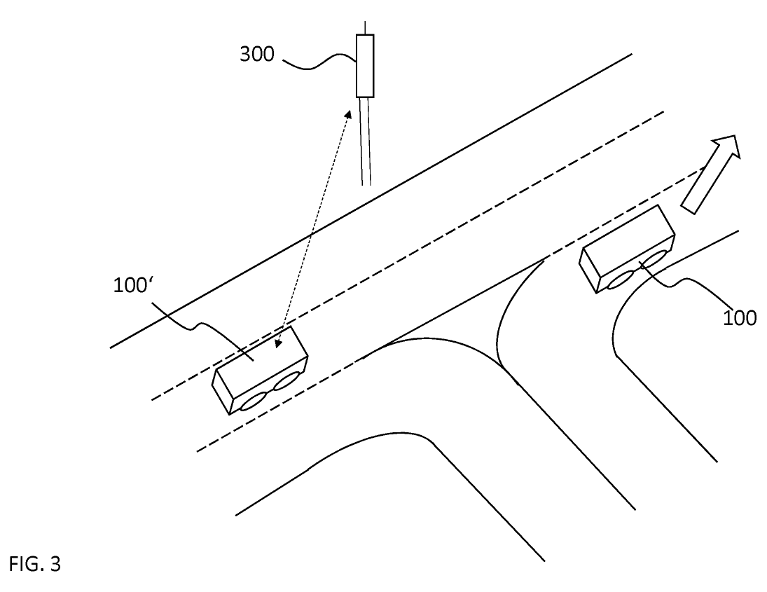

FIG. 3 shows an example of scenarios where traffic coordination is performed between CAVs, in accordance with an exemplary embodiment of the present disclosure.

As shown in FIG. 3, it is proposed to use MCMs transmitted by the road infrastructure to suggest individualized maneuvers to specific CAVs to address certain traffic situations. For example, a roadside unit 300 located at a merging section may be configured to suggest a highway CAV 100’ to adapt its speed to let an on-ramp CAV 100 safely and efficiently merge on the highway.

However, maneuver coordination is not initially possible with traffic users that are non-cooperative (NC) (e.g., legacy vehicles as well as automated vehicles, pedestrian, bikers, and other traffic users that cannot share planned intended maneuvers via V2X because not at all equipped with V2X, or using incompatible V2X radio technologies and standards), and/or non-automated (NA) (e.g., legacy vehicles, pedestrian, bikers, and other traffic users that cannot compute planned intended maneuvers, and hence cannot share it via V2X).

According to the present disclosure, a roadside device and method for traffic coordination, particularly between CAV and NA-NCs, are provided.

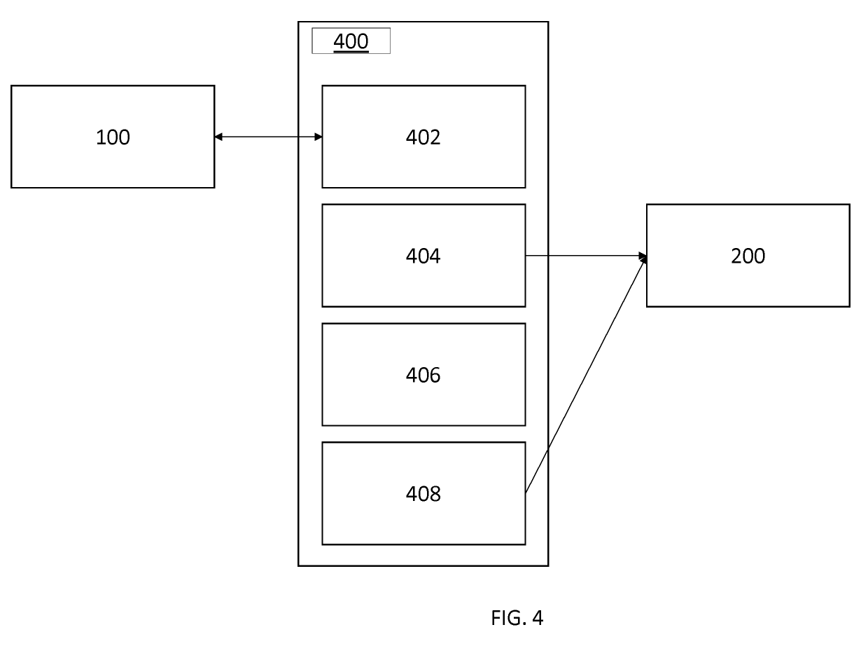

FIG. 4 illustrates an example of a schematic diagram of a roadside device for traffic coordination, according to an exemplary embodiment of the present disclosure.

According to an exemplary embodiment of the present disclosure, a software application may be applied at critical road infrastructure locations (e.g. unsignalized intersections, roundabouts, highway entries/exits, etc.). According to an exemplary embodiment, this application may comprise a catalogue of situation-specific relevance check algorithms to dynamically identify maneuver coordination needs between CAVs and non-automated and/or non-cooperative traffic users. Inputs for these algorithms may comprise V2X maneuver coordination messages received from CAVs and detections of non-automated and/or non-cooperative traffic users achieved with locally available sensors. As relevance checks give positive results (i.e. the traffic users that should establish maneuver coordination are identified), the method may comprise running “conversion” algorithms to compute dedicated coordination outputs suitable to the relevant traffic users. Outputs for CAVs may be computed by converting the observed behavior of non-cooperative and/or non-automated traffic users into maneuver coordination messages; outputs for non-cooperative traffic users may be computed by converting maneuver coordination messages received from CAVs into suitable signals. These outputs may then be communicated to CAVs via V2X and to non-automated and/or non-cooperative traffic users via suitable means.

As shown in FIG. 4, the roadside device 400, according to an exemplary embodiment of the present disclosure, may comprise a transceiver 402, a detector 404, and a processor 406. According to an exemplary embodiment, the roadside device 400 may further comprise an optical unit 408.

The transceiver 402 may be configured to communicate with the CAV 100. The transceiver may be configured to receive a first maneuver coordination message (MCM) from the CAV 100. The first MCM may be configured to inform of the intended maneuver of the CAV 100. For example, the MCM may be configured to indicate that the CAV 100 is trying to enter a merging section of a highway or roundabout. The transceiver 402 may be configured to transmit a second MCM to the CAV 100. The term “first” and “second” are added for the purpose of easier distinction, but the internal structure and contents of the first MCM and second MCM may be similar or even identical. The second MCM may be configured to indicate whether the CAV 100 needs to change the intention or not. For example, the roadside device 400 may be configured to determine whether the intended maneuver of the CAV 100 can be maintained or not, and, based on the determination, the roadside device 400 may be configured to generate a second MCM and transmit the second MCM to CAV 100 via the transceiver 402.

Although one CAV 100 is illustrated in FIG. 1, the transceiver 402 (or the roadside device 400) may be configured to communicate with multiple CAVs.

The transceiver 402 may be configured to constantly receive Maneuver Coordination Messages (MCMs) from CAVs at the target location. The target location may refer to the place where a collision may occur. For example, the target location may be a merging section of a highway or a roundabout.

The transceiver 402 may be configured to constantly monitor, via reception and interpretation of MCMs, if a CAV executes previously generated maneuvering suggestions and updates its intended maneuvering behavior accordingly.

The detector 404 may be configured to detect a target object 200. According to an exemplary embodiment, the target object 200 may comprise one of a non-automated vehicle, a non-cooperative vehicle, a bicycle/bike, a pedestrian, and/or other suitable non-automated vehicle. That is, the target object 200 may not inform about its intended maneuvering behavior by transmitting MCMs and similarly may not be influenced by received MCMs. In this sense, the target object 200 may be also referred to as NA-NC. In other words, the target object 200 may not support communication using MCMs.

The detector 404 may be disposed on the top portion of the roadside device 400. The detector 404 may comprise any types of sensor, for example, camera, radars, or lidars, etc., or combination thereof. The detector 404 may be configured to detect a target object, driving or walking along a path that would likely conflict with the intended maneuver of CAV 100. For example, the target object 200 may be driving on a highway lane merging with an entry section, and the intended maneuver of the CAV may be to enter the entry section. For example, the target object 200 may be driving along an internal circle of a roundabout, and the intended maneuver of the CAV may be to enter the roundabout.

The processor 406 may be configured to predict a trajectory of the target object 200. According to an exemplary embodiment, the processor 406 may be configured to constantly predict the trajectory of the target object 200.

The processor 406 may be configured to determine whether the predicted trajectory of the target object 200 conflicts with the intended maneuver of the CAV 100. The processor 406 may be configured to generate a coordination message for CAV 100 depending on the determination, which will be described later in further details.

For any couple (e.g., CAVx, NA-NCy), the available maneuvering behaviors may be used to continuously run relevance check algorithms following the rules of pre-defined but extendable maneuvering situations for specific locations. If any of the relevant check is passed, the couple (CAVx, NA-NCy) can benefit from maneuver coordination. In this case, the processor 406 may be configured to run two conversion algorithms in parallel: an algorithm configured to convert the predicted maneuver of target object 200 into V2X MCMs transmitted to CAV 100, where the MCMs may describe the predicted maneuver/trajectory of target object 200, but can also convey maneuvering advices that CAV 100 should execute in reaction; an algorithm configured to convert the intended maneuver of CAV 100 (received via V2X) into signals for target object 200, where the signals may describe the intended maneuver of CAV 100, but can also convey maneuvering advices that the target object 200 should execute in reaction.

The processor 406 may be configured to orchestrate the conversion algorithms for any couple (CAVx, NA-NCy) so that output maneuvring advices (in MCMs or signals) do not conflict with those for other couples. If maneuver coordination is not needed any longer for the couple (CAVx, NA-NCy), then previously generated MCMs or signals may be canceled.

In relation to CAV 100, the processor 406 may be configured to constantly update the intended maneuvering behavior of CAVs by reading subsequent received MCMs.

When it is determined that the predicted trajectory of the target object conflicts with the intended maneuver of the CAV 100, the processor 406 may be configured to provide a coordination message in in a way that the coordination message to a signal that can be seen by a user of the target object 200 when it is determined that the predicted trajectory of the target object conflicts with the intended maneuver of the CAV 100. In other words, the coordination message may be signalized such that the coordination message can be recognized and interpreted by a human. In case the target object 200 is an NC vehicle, the user is a driver of the NC vehicle. In case the target object 200 is a pedestrian, the user of the target object 200 may be the pedestrian.

According to an embodiment, the roadside device 400 may further comprise an optical unit 408. The optical unit 408 may be configured to illuminate at least a part of a road along the predicted trajectory of the target object 200. The optical unit 408 may be a light emitting device (LED) beam. The processor 406 may be configured to cause the optical unit 408 to display the CAV’s intended maneuver encoded in its maneuver coordination messages on the road along the predicted trajectory of the target object 200.

According to an exemplary embodiment, the processor 406 may be configured to convert the CAV’s intended maneuver encoded in its maneuver coordination message into navigation information transmitted to a navigation system of the target object 200. Thus, the CAV’s coordination message can be displayed on the navigation system.

The detector 404 may be configured to keep monitoring a movement of the target object 200. The detector 404 may be configured to constantly detect target object 200 with local sensors and observe their movements at the target location.

According to an embodiment, the detector 404 may be configured to keep monitoring a movement of the target object 200 after the coordination message is signaled. The processor 406 may be configured to constantly monitor if the target object 200 actually perform maneuvers as predicted. If not, the prediction of the trajectory of the target object 200 may be updated. The monitored movement of the target object 200 may be at least one of a moving speed and a moving path of the target object 200.

As described above, the detector 404 may be configured to constantly monitor if the target object 200 executes previously generated maneuvering suggestions and update the prediction of their intended maneuvering behavior accordingly.

According to an exemplary embodiment, the processor 406 may be configured to generate a second sequence of MCMs to be transmitted to the CAV 100 based on the monitored movement the target object 200. More specifically, the second sequence of MCMs indicates that the intended maneuver of the CAV 100 can be maintained, when the movement of the target object 200 is adapted according to the signaled converted coordination message.

The second sequence of MCMs may indicate that the intended maneuver of the CAV has to be changed, when the movement of the target object is not adapted. For example, despite of the signaling of coordination messages, if the target object 200 is still approaching to the point where the collision is likely to happen with same states, for example, driving speed and driving direction, the processor 406 may be configured to generate the second sequence of MCMs to inform the CAV 100 that entering into the merging section is dangerous. Thus, the second sequence of MCMs may include instructions to change the intended maneuver of the CAV 100.

On the other hand, the second sequence of MCMs may indicate that the intended maneuver of the CAV 100 can be maintained, when the movement of the target object 200 is adapted according to the signaled converted coordination message. For example, after signaling the

converted coordination message to the target object 200, the movement (driving status) of the target object 200, for example, driving/moving speed and/or driving/moving path of the target object 200, is changed, the processor 406 may consider that the risk of collision has been removed.

According to an exemplary embodiment of the present disclosure, CAVs may be configured to coordinate their maneuvers even with non-automated and/or non-cooperative (NA-NC) traffic users. Therefore, the traffic safety and efficiency potential of maneuver coordination may be maintained without exclusively depending on the presence of cooperative automated road users.

As previously highlighted, the proposed method may be applied to road infrastructure locations where coordination between CAVs and NA-NCs would bring traffic safety and efficiency benefits.

At a specific road infrastructure location, the proposed method may be configured to identify coordination needs and enable coordination based on a pre-configured but extendable set of traffic situations.

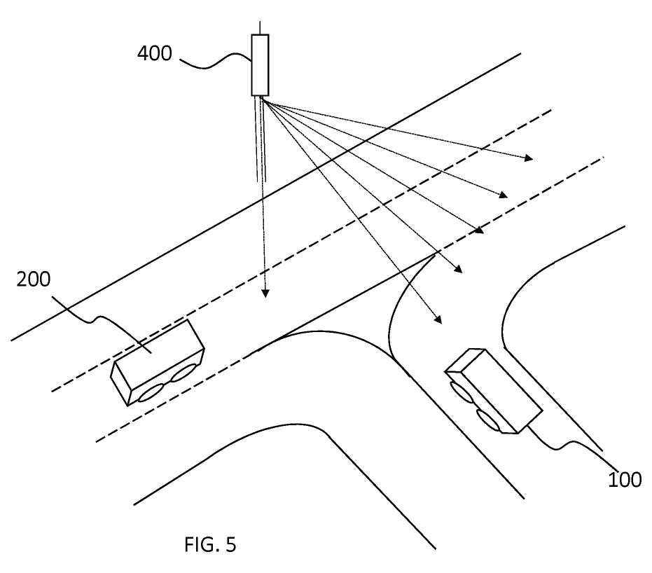

FIG. 5 illustrates an example of scenarios where a traffic coordination is applied, according to an exemplary embodiment of the present disclosure.

As shown in FIG. 5, the roadside device 400, more particularly, the processor 404, may be configured to run on an RSU strategically placed at the merging section. The CAV 100 may be configured to announce its highway merge intention via MCMs including merging trajectory, safe gap needed to merge etc.

At time t, the roadside device 400 may be configured to receive MCMs from CAV 100 and detects the target object 200 with own sensors. At time t, the roadside device 400 may be configured to consider the two vehicles as mutually relevant for the merging situation and in need of maneuver coordination.

From time t till coordination is needed, the roadside device 400 may be configured to convert the CAV 100 merging intentions into signals usable by the target object 200. For example, a moving set of LED beams may illuminate the highway along the CAV 100 intended merging trajectory as contained in its MCM. Also by way of example, as a maneuver advice, a moving LED beam may illuminate the highway at the safe gap that the CAV 100 needs to merge (this info is also contained in the CAV’s MCM).

As a result of these signals, the target object 200 may keep the gap to let the CAV 100 merge.

From time t till coordination is needed, the roadside device 400 may be configured to observe the target object 200 and updates predictions of its trajectory (intended behavior). In this case also its compliance to the advised safe gap can be checked.

From time t till coordination is needed, the roadside device 400 may be configured to convert the target object 200 predicted behavior into MCMs for the CAV 100. According to an exemplary embodiment, MCMs may comprise a target object‘s current predicted trajectory not conflicting with the CAV‘s merging trajectory and respecting the needed safe gap. As a result, maneuver coordination is enabled. The CAV 100 knows that the target object 200 will let it merge and may safely and efficiently execute the merging maneuver.

Without the roadside device 400, according to the present disclosure, the target object 200, which is non-cooperative (NC), cannot exchange MCMs to run a maneuver coordination protocol. Due to lack of explicit maneuver coordination with the target object 200, the CAV 100 might act more conservatively and discard possible merging opportunities, resulting in less traffic efficiency, or take risky merging decisions, resulting in less traffic safety.

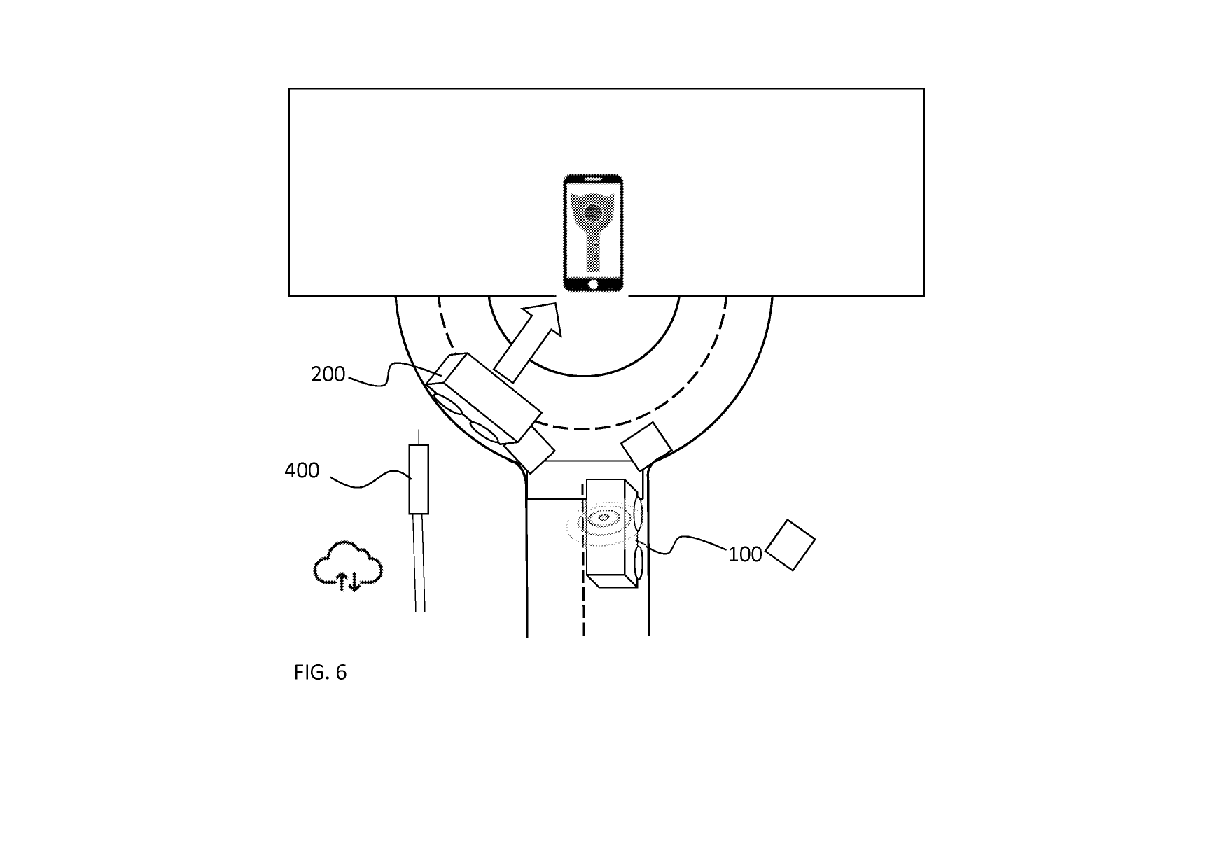

FIG. 6 illustrates an example of scenarios where a traffic coordination is applied, according to an exemplary embodiment of the present disclosure.

As shown in FIG. 6, the roadside device 400 may be connected with the processor 404 that, in this case, runs on the cloud and monitors the roundabout. The CAV 100 may announce its drive-in intention via MCMs transmitted to the cloud including trajectory, speed, etc.

At time t, the roadside device 400 may receive MCMs from CAV 100 and detects the target object (biker, being a NA traffic user) 200 with own sensors. At time t, the roadside device 400 may consider the two traffic users as mutually relevant for the traffic situation and in need of maneuver coordination.

From time t till coordination is needed, the roadside device 400 may convert the CAV 100 merging intentions into signals for the target object 200. For example, the NA biker may use a smartphone navigation application that shows the CAV 100 intended drive-in trajectory onto the roundabout as contained in its MCM. As a result of this signal, the biker is aware about when and where exactly the CAV 100 will drive into the roundabout.

From time t till coordination is needed, the roadside device 400 may observe the target object 200 and update predictions of its trajectory (intended behavior). In this case, the NA biker will leave the roundabout at the same road where the CAV is arriving.

From time t till coordination is needed, the roadside device 400 may convert the predicted behavior of the target object 200 into MCMs for the CAV 100 and update this info while constantly observing the target object 200. MCMs may comprise the NA biker‘s current predicted trajectory not conflicting with the CAV‘s drive-in trajectory.

As a maneuver advice, the MCM may additionally contain the speed that the CAV 100 can keep to safely approach and enter the roundabout (the CAV does not need to stop to check what the biker will do). As a result, maneuver coordination is enabled. The CAV 100 knows that the target object 200 will leave the roundabout at the same road where it is arriving. As it is aware that a conflict does not exist, the CAV 100 can safely and efficiently enter the roundabout.

Without the roadside device 400, according to the present disclosure, the target object 200, i.e., a biker which is not automated (NA), cannot generate MCMs to run a maneuver coordination protocol. Due to lack of explicit maneuver coordination with the target object 200, the CAV 100 may act more conservatively and discard possible drive-in opportunities, resulting in less traffic efficiency, or take risky drive-in decisions, resulting in less traffic safety.

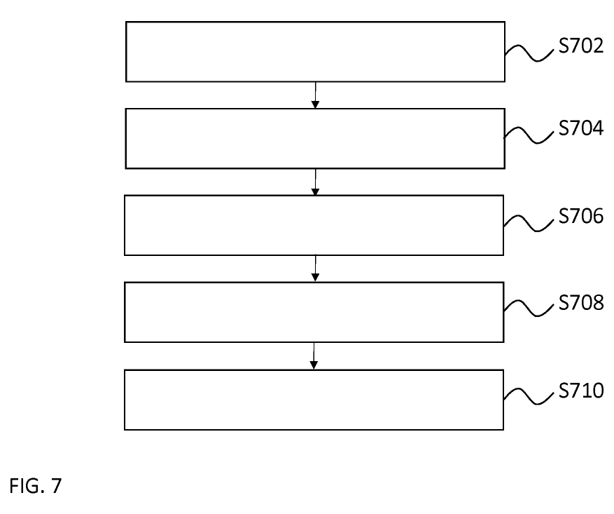

FIG. 7 illustrates an example of a flow chart showing a method for traffic coordination, according to an exemplary embodiment of the present disclosure.

In step S702, the transceiver 402 may be configured to receive a first maneuver coordination message, MCM, from a cooperative automated vehicle, CAV 100, informing an intended maneuver of the CAV 100. The transceiver 402 may be further configured to keep updating the intended maneuver of CAV 100 as new MCMs are constantly received, also after coordination signals for the target object 100 are generated.

In step S704, the detector 404 may be configured to detect a target object 200. The target object 200 may not support a MCM to be operated. The target object 400 may be one of a non-automated vehicle, a non-cooperative vehicle, a bike, and a pedestrian.

The detector 404 may be further configured to keep monitoring a movement of the target object 200 after the coordination message is displayed. The monitored movement of the target object 200 may be at least one of a moving speed and a moving path of the target object.

In step S706, the processor 406 may be configured to predict a trajectory of the target object 200.

In step S708, the processor 406 may be configured to determine whether the predicted trajectory of the target object 200 conflicts with the intended maneuver of the CAV 100.

In step S710, the processor 406 may be configured to provide a coordination message in in a way that the coordination message to a signal that can be seen by a user of the target object 200 when it is determined that the predicted trajectory of the target object conflicts with the intended maneuver of the CAV 100. According to an exemplary embodiment, the roadside device 400 may further comprise an optical unit 408 configured to illuminate at least a part of a road along the predicted trajectory of the target object. The processor 406 may be configured to cause the optical unit 408 to display the coordination message on the road along the predicted trajectory of the target object. The optical unit 408 may be a light emitting device, LED, beam. The processor 406 may be configured to send the coordination message to a navigation system of the target object 200 such that the coordination message is displayed on its navigation system.

The processor may be further configured to generate a second sequence of MCMs to be transmitted to the CAV 100 based on the monitored movement the target object. The second sequence of MCMs may indicate that the intended maneuver of the CAV 100 can be maintained, when the movement of the target object 200 is adapted according to the coordination message. The second sequence of MCMs indicates that the intended maneuver of the CAV 100 has to be changed, when the movement of the target object 200 is not adapted.

According to an exemplary embodiment, the predicted trajectory of the target object 200 may be located on a highway lane merging with an entry section, and the intended maneuver of the CAV 100 may be to enter the entry section. The predicted trajectory of the target object 200 may be located on an internal circle of a roundabout, and the intended maneuver of the CAV 100 may be to enter the roundabout.

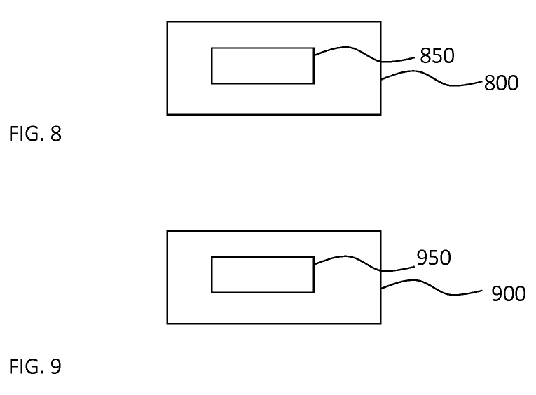

FIG. 8 illustrates a schematic block diagram illustrating a computer program product 800 according to an exemplary embodiment of the present disclosure. For example, the computer program product 800 may comprise a computer program product 800 comprising executable program code 850 configured to, when executed (e.g. by the apparatus 400), perform the method according to the first aspect of the present disclosure, in particular the method as has been described with respect to FIG. 1 through FIG. 7 in the foregoing.

FIG. 9 illustrates a schematic block diagram illustrating a non-transitory computer-readable data storage medium 900 according to an exemplary embodiment of the present disclosure. The non-transitory computer-readable data storage medium 900 may comprise a data storage medium 900 comprising executable program code 950 configured to, when executed (e.g. by the apparatus 400), perform the method according to the first aspect of the present disclosure, in particular the method as has been described with respect to FIGS. 1-7 in the foregoing.

Although the present disclosure has been described in the above by way of preferred embodiments, it is not limited thereto, but rather can be modified in a wide range of ways. In particular, the disclosure can be changed or modified in various ways without deviating from the core of the disclosure.

1. A roadside device for performing traffic coordination, the roadside device comprising:
a transceiver configured to receive a first maneuver coordination message (MCM) from a cooperative automated vehicle (CAV), wherein the MCM is configured to inform an intended maneuver of the CAV;
a detector configured to detect a target object; and
a processor configured to:
determine whether a predicted trajectory of the target object conflicts with the intended maneuver of the CAV; and
provide a coordination message as a signal viewable to a user of the target object when it is determined that the predicted trajectory of the target object conflicts with the intended maneuver of the CAV.

2. The roadside device according to claim 1, wherein the processor is configured to predict the trajectory of the target object.

3. The roadside device according to claim 1, further comprising an optical unit configured to illuminate at least a part of a road along the predicted trajectory of the target object.

4. The roadside device according to claim 3, wherein the processor is configured to cause the optical unit to display the coordination message on the road along the predicted trajectory of the target object.

5. The roadside device according to claim 3, wherein the optical unit comprises a light emitting diode (LED) beam.

6. The roadside device according to claim 1, wherein the processor is configured to convert the coordination message into a format suitable to a navigation system of the target object such that the coordination message is signalized on the navigation system.

7. The roadside device according to claim 1, wherein the detector is further configured to keep monitoring a movement of the target object after the coordination message is displayed.

8. The roadside device according to claim 7, wherein the monitored movement of the target object is at least one of a moving speed and a moving path of the target object.

9. The roadside device according to claim 7, wherein the processor is configured to generate a second MCM to be transmitted to the CAV based on the monitored movement the target object.

10. The roadside device according to claim 9, wherein, when the movement of the target object is adapted according to the coordination message, the second MCM indicates that the intended maneuver of the CAV can be maintained.

11. The roadside device according to claim 9, wherein, when the movement of the target object is not adapted, the second MCM indicates that the intended maneuver of the CAV (100) has to be changed.

12. The roadside device according to claim 1, wherein the target object does not support a MCM to be operated.

13. The roadside device according to claim 1, wherein the target object comprises one of a non-automated vehicle, a non-cooperative vehicle, a bike, and a pedestrian.

14. The roadside device according to claim 1 wherein:
the predicted trajectory of the target object is located on a highway lane merging with an entry section, and
the intended maneuver of the CAV is to enter the entry section.

15. The roadside device according to claim 1, wherein:
the predicted trajectory of the target object is located on an internal circle of a roundabout, and
the intended maneuver of the CAV is to enter the roundabout.

16. A method of traffic coordination performed by a roadside device, the method comprising:
receiving a first maneuver coordination message (MCM) from a cooperative automated vehicle (CAV), wherein the MCM is configured to inform an intended maneuver of the CAV;
detecting a target object; and
using a processor:
determining whether a predicted trajectory of the target object (200) conflicts with the intended maneuver of the CAV; and
providing a coordination message as a signal viewable by a user of the target object when it is determined that the predicted trajectory of the target object conflicts with the intended maneuver of the CAV.

17. The method of claim 16, further comprising, using the processor, predicting the trajectory of the target object.

18. The method according to claim 16, further comprising, using an optical unit, displaying the coordination message on a road along the predicted trajectory of the target object,
wherein the optical unit is configured to illuminate at least a part of the road along the predicted trajectory of the target object.

19. The method according to claim 18, wherein the optical unit comprises a light emitting diode (LED) beam.

20. The method according to claim 16, further comprising, using the processor, converting the coordination message into a format suitable to a navigation system of the target object such that the coordination message is signalized on the navigation system.
